(19) United States
(12) Patent Application Publication
(10) Pub. No.: US 2023/0371444 A1
(43) Pub. Date: Nov. 23, 2023

(54) Method and System of Growing Plants in a Confined Space

(71) Applicant: LOGIQS B.V., MAASDIJK (NL)

(72) Inventor: Gerrit Johannes van Staalduinen, MAASDIJK (NL)

(73) Assignee: LOGIQS B.V., MAASDIJK (NL)

(21) Appl. No.: 18/245,075

(22) PCT Filed: Sep. 8, 2021
(86) PCT No.: PCT/NL21/50543

§ 371 Date: Mar. 13, 2023

(30) Foreign Application Priority Data
Sep. 11, 2020 (NL) 2026447

(51) Int. Cl. A01G 9/029; A01G 9/02; B65G 1/04

(52) U.S. Cl. CPC A01G 9/0299; A01G 9/023; A01G 9/027; B65G 1/0492

(57) ABSTRACT

A method of growing plants in a confined space makes use of containers for plants. The containers are stored using a system including a three-dimensional array of array elements, said three-dimensional array of array elements having a stack of two-dimensional arrays of array elements. Each two-dimensional array has a grid of tracks defining a first track for moving a container in an X-direction, and second tracks for moving the container in a Y-direction. Containers are moved using a shuttle. To improve the use of the space available for growing plants, the containers have to be moved from the first track to a second track efficiently. Thus, moving a container to the second track comprises lifting at least one of the containers and the shuttle by bringing moveable track sections from a relatively low position to a relatively high position, and moving the container to the second array element.

### BACKGROUND

A prior art system is known where the containers are moved in the X-direction along a track, wherein the shuttle can't enter the array elements defining said track. The shuttle is capable of running parallel to said array elements defining the track for movement of containers in the X-direction, but only if the shuttle doesn't transport a container. The shuttle can transport a container in the Y-direction only and from there push it onto or pull it from the track for moving containers in the X-direction. The shuttles are limited to transporting containers in the Y-direction only.

### SUMMARY

The present invention relates to a method of growing plants in a confined space, said method using
a plurality of containers for supporting plants, and
a system for storing the containers within the confined space for growing the plants, said system
comprising a three-dimensional array of array elements, said three-dimensional array of array elements comprising a stack of two-dimensional arrays of array elements, and
having
a first main side,
a second main side opposite of the first main side, and
a third main side and a fourth main side, said third main side and said fourth main side extending from the first main side to the second main side;
wherein each two-dimensional array defines a grid of tracks,
said two-dimensional array having
a first side,
a second side opposite of the first side, and
a third side and a fourth side, said third side and said fourth side extending from the first side to the second side;
and
said grid of tracks defining
at least one first track for moving a container in an X-direction transverse to the third side, and
a plurality of second tracks for moving the container in a Y-direction transverse to the first side;
wherein the array elements of the two-dimensional array of array elements are chosen from
a first array element comprising a first track section allowing transport of a container in the X-direction, and
a second array element for storing the containers, said second array element comprising a second track section allowing transport of a container in the Y-direction;
and
a device for moving a container in a vertical direction;
wherein the method comprises the steps of
moving a container along a first track in an X-direction until a second track is reached,
moving said container along the second track to store said container in a second array element,
growing the plants in said stored container,
after growing the plants, retrieving said container from the second array element.

A method of growing plants in a confined space, such as a greenhouse, is known in the art. The confined space involves a substantial investment, and it is desirable to optimize the use of surface area in the confined space so as to increase the yield of plants, which may be of any type (ornamental, herbs, vegetables, plants bearing seeds or fruits of any kind). As walking space between containers would reduce the surface area for growing plants, it is known to put the plants in containers and place the containers adjacent to each other in an array, defining a growth area which is typically not accessed by personnel in charge of growing plants. To save on labour cost, it is known to use a grid of tracks to facilitate moving the containers. The tracks may be provided with driven wheels and/or use is made of a shuttle vehicle that pulls or drags a container along a track, or a combination of both. To store or move a container, the system is arranged for lifting the container to put it on the first track and lift it from the first track.

The object of the present invention is to provide a method with improved use of the space available for growing plants.

To this end, a method according to the preamble is characterized in that
the second array element comprises second shuttle track sections for a shuttle, said second shuttle track sections being
located at a level lower than the second track sections for moving the container, and
running parallel with the second track sections for storing the container;
allowing the shuttle to move the container with the shuttle on the second shuttle track sections;
the first array element comprises moveable track sections capable of being in a relatively low position and in a relatively high position, wherein said moveable track sections are chosen from at least one of
i) container track sections for moving the container in the Y-direction, and
ii) shuttle track sections for moving the shuttle in the Y-direction;
wherein the system comprises at least one actuator for moving the moveable track sections between the first relatively low position and the second relatively high position;
wherein the step of moving the container to the second track comprises lifting at least one of the container and the shuttle by bringing the moveable track sections from the first relatively low position to the second relatively high position, and moving the container using the shuttle to the adjacent second array element.

Thus the shuttle may move in the first array elements in the X-direction or the Y-direction as desired.

Over the prior art, and depending on the embodiment, the present invention has several advantages. Firstly, the number of different array elements is reduced by one, the prior art array elements allowing for the shuttle (but not the container) to be moved both in the X-direction and Y-direction no longer being necessary. Secondly, this space where the shuttle could move in two directions was previously not available for growing plants, but with the present invention it is. Thirdly, lifting the shuttle is quicker than the prior art step of pushing the container from the track where the shuttle is onto the track where the shuttle couldn't come; allowing the shuttle to move more containers per hour than before. Fourthly, the shuttle may move containers in the X-direction, obviating driven wheels for containers in the first track. Finally, the shuttle can now cross the track for movement of containers in the X-direction, eliminating the restriction that the track for moving in the X-direction must be at an end of a two-dimensional array or comes with the requirement that an additional track in the X-direction is necessary for moving the shuttle adjacent to the track for moving the container in the X-direction. Each of these advantages by itself makes the method according to the present invention more efficient.

The confined space may be a greenhouse but may also be an indoors chamber or even a sea container such as used for shipping.

Moving the at least one container to a desired level (two-dimensional array) of the three-dimensional array may be done using a lift or a robot.

Every pair of adjacent two-dimensional arrays may have third array elements at the same location capable of moving a container from the level of a first two-dimensional array to an adjacent second two-dimensional array.

The second array elements typically comprise a light source (such as an array of LEDs) for illuminating the plants supported by a container stored in said second array element.

According to a favourable embodiment, the first array element comprises container track sections, said container track sections being capable of being
in a first relatively low position allowing a shuttle to transport the container in the X-direction, and
in a second relatively high position in line with the second track sections of the adjacent second array element for allowing the movement of the container in the Y-direction;
wherein the system comprises at least one actuator for moving the container track sections between the first relatively low position and the second relatively high position;
and wherein the step of lifting the shuttle also comprises the step of moving the container track sections from the first relatively low position to the second relatively high position in line with the second track sections of the adjacent second array element for moving the container in the Y-direction to the second track.

This helps to ensure that the container is moved to the adjacent second array element reliably.

The actuator may be the same actuator that is involved in moving a shuttle track section of the first array element or an additional actuator.

According to a favourable embodiment, the first track sections of the first array elements define the first track and comprise passive wheels for supporting the container when it is moved in the X-direction, and
the first array elements comprise second shuttle track sections, said second shuttle track sections,
extending in the X-direction for supporting the shuttle used for moving the container, and
located at a level lower than the first track sections for moving the container;
wherein to move the container along the first track, the shuttle is used to move said container.

Thus the shuttle may be used for moving a container in a) the first direction, and b) the second direction. The use of driven wheels along the tracks is avoided, not only saving the cost of investment, but also reducing the risk of interruption for maintenance and thus loss of yield.

Typically, the second shuttle track sections are lowered to a height not higher than top of the second shuttle track sections of the first array element although minor deviations may not impede transport of a container in the X-direction.

To move the container
from the first track to the second track for storing a container
the container is raised using the container track sections of the first array element to be in line with the second track sections of the adjacent second array element, and
the shuttle is raised using the shuttle track sections of the first array element to be in line with the shuttle track sections of the adjacent second array element;
from the second track to the first track for retrieval of a container
the container is moved on the container track sections of the first array element while in the relatively high position of said container track sections and the shuttle is moved on the shuttle track sections of the first array element while in the second relatively high position of said shuttle track sections, and
the relatively high sections are lowered.

According to a favourable embodiment, the first array elements comprise container track sections with drivable wheels for moving the container in the X-direction; and
the first array elements comprise second shuttle track sections, said second shuttle track sections,
extending in the X-direction for supporting the shuttle used for moving the container, and
located at a level lower than the first track sections;
wherein to move the container along the first track, the driven wheels are used to move said container.

Thus the use of the shuttles for moving containers may be limited to moving containers in the Y-direction, reducing the amount of power needed to power the shuttles. This also allows for a battery pack with a reduced height to be used in the shuttles, allowing the shuttles to be thinner and thus the array elements to have a reduced height, allowing a more effective use of the growth space.

To move the container
from the first track to the second track for storing a container
the container is raised using the container track sections of the first array element to be in line with the second track sections of the adjacent second array element, and
the shuttle is raised using the shuttle track sections of the first array element to be in line with the shuttle track sections of the adjacent second array element;
from the second track to the first track for retrieval of a container
the container is moved on the container track sections of the first array element while in the relatively high position of said container track sections and the shuttle is moved on the shuttle track sections of the first array element while in the second relatively high position of said shuttle track sections, and
the relatively high sections are lowered.

According to a favourable embodiment, the second array elements of the grid of tracks comprise a light source, and light is provided to plants grown in a container stored in a second array element.

Thus a array element helps to ensure that the plants receive more light and/or light of a specific range of wavelengths.

According to a favourable embodiment, the device comprises an elevator for moving a container from the level of a two-dimensional array to the level of another two-dimensional array.

Thus containers may be provided to a grid of tracks at any level of the system. Prior art methods allowed a container to enter (or leave) a two-dimensional array for transport in a vertical (Z-) direction in both the X- and the Y-direction, but for the shuttle only one direction was available. With the method according to the invention, a shuttle may enter (or leave) the two-dimensional array in any of these directions.

The device may be a robot comprising a robot arm.

According to a favourable embodiment, the elevator for moving a container in a vertical direction is a third array element capable of moving a container in the first direction and the second direction.

This saves further space. The third array elements may be provided at an upright corner of the three-dimensional array, or at a distance from the corners of a main side of the three-dimensional array, and in fact anywhere in the three-dimensional array. A stack of third array elements will have both the shuttle track sections and optionally the container track sections of a first array element, wherein all these track sections will be raised, for example using belts.

According to a favourable embodiment, the shuttle comprises
a first set of first shuttle wheels for travelling in the X-direction, said first shuttle wheels defining a first shuttle wheel base plane and the first shuttle wheels having first axes of rotation, and
a second set of second shuttle wheels for travelling in the Y-direction, said second shuttle wheels defining a second shuttle wheel base plane and the second shuttle wheels having second axes of rotation;
wherein the first shuttle wheel base plane is lower than the second shuttle wheel base plane and with the first axes of rotation and the second axes of rotation projected on the first shuttle wheel base plane said projected second axes of rotation being transverse to the projected first axes of rotation.

In prior art shuttles, the shuttle would take care of the change of direction by changing the height of some of its wheels. According to this preferred embodiment, the wheel base planes are fixed with respect to the shuttle as the first array element will change the direction of the shuttle by lifting or lowering the shuttle. For example, by lifting the first wheels from the first track and supporting the shuttle by the second wheels on the shuttle track sections of the first array element, the shuttle may move in the Y-direction with the lower ends of the first wheels protruding below the second wheel base plane.

As the shuttle itself does not require further facilities (actuators etc) for changing the direction of the shuttle, this allows the thickness of the shuttle to be relatively small and hence the space that is required for the shuttle to travel in the array is reduced. This allows for more efficient use of the available space for actually growing plants.

According to a favourable embodiment, the moveable track sections comprise
moveable container track sections, said container track sections being capable of being
in a first relatively low position allowing a shuttle to transport a container in the X-direction, and
in a second relatively high position in line with the second container track sections of an adjacent second array element, allowing shuttle transport in the Y-direction; and
moveable shuttle track sections, said shuttle track sections being capable of being
in a first relatively low position allowing a shuttle to transport a container in the X-direction, and
in a second relatively high position in line with the shuttle track sections of an adjacent second array element, allowing shuttle transport in the Y-direction;
wherein the system comprises at least one actuator for moving the shuttle track sections between the first relatively low position and the second relatively high position;
wherein
the step of moving a container in the X-direction to a first array element adjacent to a desired second track comprises moving said container while the second container track sections of any first array element involved in moving said container in the X-direction are not higher than the first shuttle track,
the step of moving the container to the second track comprises
lifting the container by bringing the second container track sections from the first relatively low position to the second relatively high position,
lifting the second shuttle track sections so as to support the shuttle, and
moving the container using the shuttle to the adjacent second array element.

This is embodiment allows a shuttle transporting a container in the X-direction to pass the second container track section conveniently.

Optionally at least part of the first container track section is lowered to facilitate the passage of the shuttle to or from the adjacent second array element.

Alternatively, the second shuttle track sections are used to lift the shuttle to a height that allows it to clear the first container track section and move to the adjacent second shuttle track section of the adjacent second element.

Finally, the present invention relates to a system for storing the containers within the confined space for growing the plants, said system
comprising a three-dimensional array of array elements, said three-dimensional array of array elements comprising a stack of two-dimensional arrays of array elements, and
having
a first main side,
a second main side opposite of the first main side, and
a third main side and a fourth main side, said third main side and said fourth main side extending from the first main side to the second main side;
wherein each two-dimensional array defines a grid of tracks,
said two-dimensional array having
a first side,
a second side opposite of the first side, and
a third side and a fourth side, said third side and said fourth side extending from the first side to the second side;
and
said grid of tracks defining
at least one first track for moving a container in an X-direction transverse to the third side, and
a plurality of second tracks for moving the container in a Y-direction transverse to the first side;
wherein the array elements of the two-dimensional array of array elements are chosen from
a first array element comprising a first track section allowing transport of a container in the X-direction, and
a second array element for storing the containers, said second array element comprising a second track section allowing transport of a container in the Y-direction;
and
a device for moving the container in a vertical direction, wherein the second array element comprises second shuttle track sections for a shuttle, said second shuttle track sections being
located at a level lower than the second track sections for moving the container, and
running parallel with the second track sections for storing the container;
allowing the shuttle to move the container with the shuttle on the second shuttle track sections;
the first array element comprises moveable track sections capable of being in a relatively low position and in a relatively high position, wherein said moveable track sections are chosen from at least one of
container track sections for moving the container in the Y-direction, and
ii) shuttle track sections for moving the shuttle in the Y-direction;
wherein the system comprises at least one actuator for moving the moveable track sections between the first relatively low position and the second relatively high position.

Such a system is suitable for use in the method according to the invention.

The application also relates to all preferred embodiments of the system detailed in dependent claims and as discussed for the method claim above, in any combination, repetition of which has been abstained from for the sake of brevity only.

### BRIEF DESCRIPTION OF THE DRAWINGS

The present invention will now be illustrated with reference to the drawing where

FIG. 1 shows a perspective view on a system for growing plants;

FIG. 2A to FIG. 2C show respectively a top view, a front view and a side view of a layer of the array of FIG. 1;

FIG. 3A to FIG. 3C show part of a array element of the array of FIG. 1;

FIG. 4A to FIG. 4C show three perspective views on an alternative system for growing plants;

FIG. 5 is a top view of the system of FIG. 4 corresponding to FIG. 4C;

FIG. 6A and FIG. 6B show front views of the system of FIG. 4B;

FIG. 7 shows a top view of a second alternative system;

FIG. 8A and FIG. 8B show side views of the second alternative system. of FIG. 7; and

FIG. 9 shows a detail of FIG. 8A.

### DETAILED DESCRIPTION

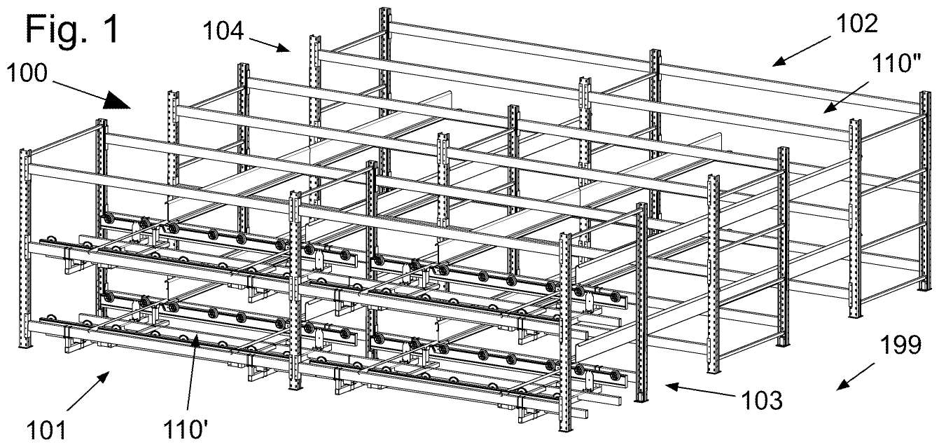

FIG. 1 shows a perspective view on a system 100 for growing plants in a confined space 199. The system 100 comprises a three-dimensional array of array element 110. The system 100 comprises a stack of two-dimensional arrays of said array elements 110. In the embodiment shown here, the system 100 comprises two layers of two-dimensional arrays, and each two-dimensional array is two array elements 110 wide and five array elements 110 long. These two layers are used for growing plants.

The three-dimensional array has a first main side 101 at the front, a second main side 102 at the back, and a third main side 103 and fourth main side 104 extending between the first main side 101 and the second main side 102.

For the purpose of explanation of the invention, the array elements 110 will be referenced to using an (X,Y,Z) coordinate system, where the array element 110′ at the lower front end left is at (1,1,1) and array element 110″ at the top right back is at (2,5)2.

The array elements 110 where Y≥2 will be used for growing plants. The array elements where Y=1 will be used for transporting containers with plants in the X-direction using first tracks 210, and for transporting plants in the Y-direction second tracks 220, as will be discussed below.

The use of system 100 will also make use of light sources for growing the plants, and devices for controlling the climate with respect to humidity and/or temperature, which are not shown here for the sake of simplicity.

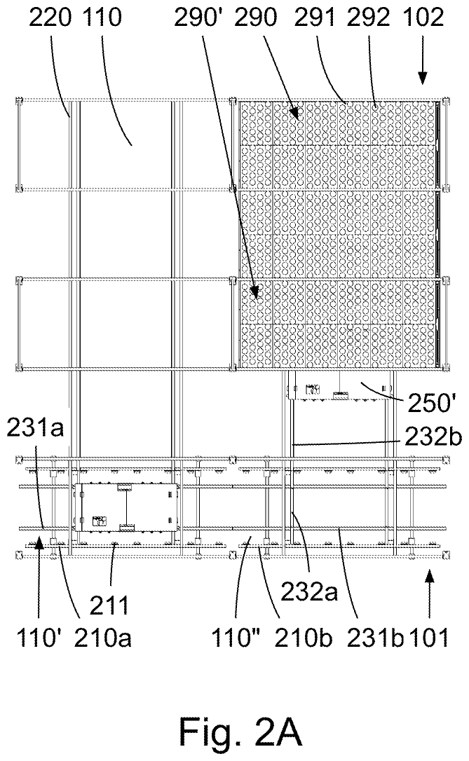

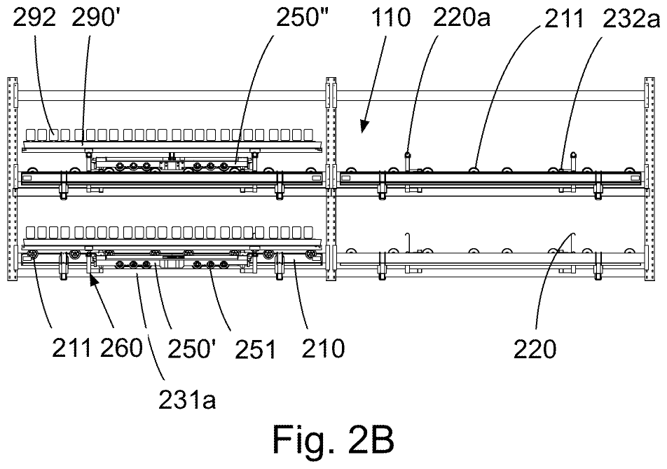

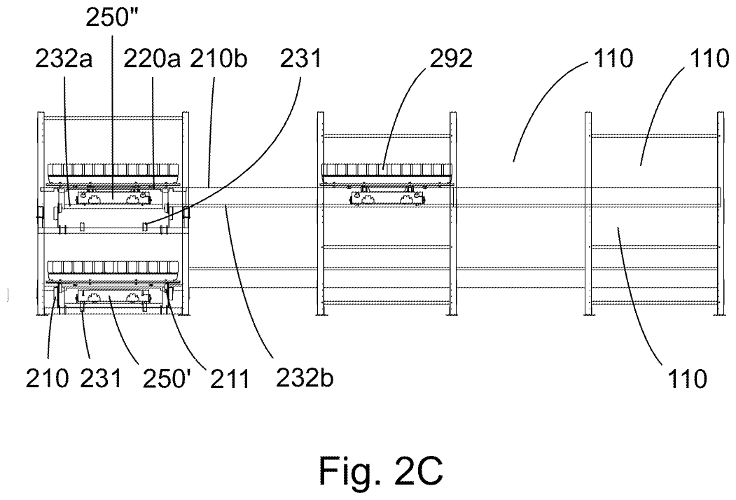

FIG. 2A to FIG. 2C show respectively a top view, a front view and a side view of a layer of the system 100 of FIG. 1.

The top view of FIG. 2A shows three containers 290 at locations (2, 3-5), each container 290 provided with 12 trays 291 containing plant plants 292.

The containers 290 will roll over second tracks 220 in the Y-direction. When the containers are stored in array elements 110, they remain on said second tracks 220.

The containers 290 are moved using shuttles 250, 250′.

Shuttle 250 can move in the X-direction along the first shuttle track 231. In FIG. 2B a horizontal frame beam 101 is not shown at the left to allow a better view on the shuttle 250 and its wheels 251 for moving over the first shuttle track 231. Array element 110′ comprises a first shuttle track section 231a and array element 110″ comprises an adjacent first shuttle track section 231b.

In the embodiment discussed here, to move a container in the X-direction, the container is supported by stationary wheels 211 provided on the first tracks 210.

To move a container 290 in the Y-direction, shuttle 250 may also move in the Y-direction, along the second shuttle track 232.

Shuttle 250′ is on its way to retrieve container 290′ after growing plants 292 (FIG. 2A).

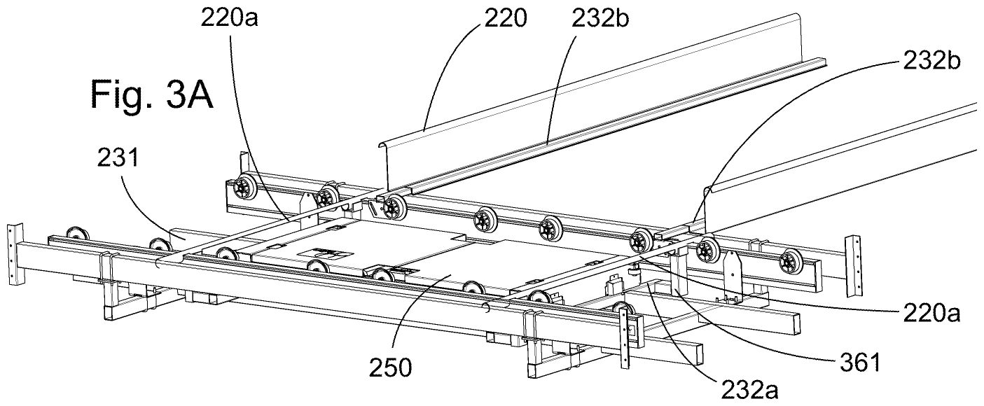

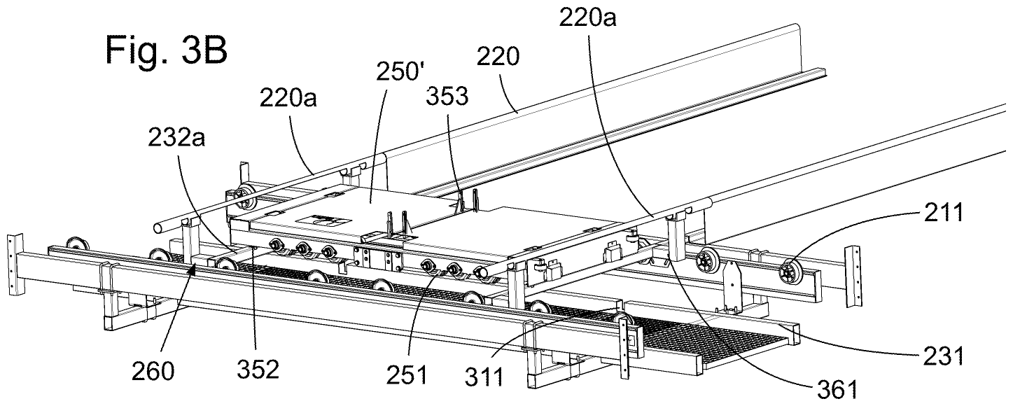

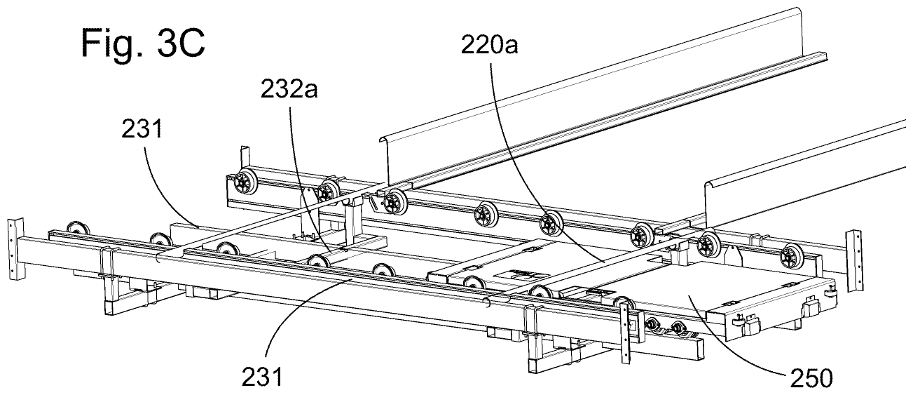

To change direction from the X-direction to the Y-direction, the container 290 and the shuttle 250 are lifted from a relatively low position (shuttle 250′ in the first layer of the system in FIG. 2B) to a relatively high position (shown for shuttle 250″ in the second layer). It makes use of an actuator 260 capable of simultaneously lifting second track sections 220a of a array element with Y=1 and the second shuttle track sections 232a of said array element for the shuttle 250. This will allow the container 290 and the shuttle 250 to continue on the corresponding tracks of the array element 110 where Y>1 (illustrated for the second layer in the middle of FIG. 2C). This will be discussed in more detail below with reference to FIG. 3.

To change direction from the Y-direction to the X-direction, the same steps are taken but in the reverse order.

FIG. 3A to FIG. 3C show part of a array element 110 of the array of FIG. 1 and illustrate how a shuttle 250 can change direction from the X-direction to the Y-direction and vice versa.

To change direction from the X-direction to the Y-direction, the shuttle 250 is lifted from a relatively low position (FIG. 3A) where it is on the first shuttle track 231 by lifting second shuttle track sections 232a. Where in the lower position, first shuttle wheels 251 that allow movement of the shuttle 250 in the X-direction rest on the first shuttle track 231 while second shuttle wheels 352 are not in contact at their wheel base, lifting the second shuttle track sections 232a causes said second shuttle wheels 352 to contact said second shuttle track sections 232a which in the relatively high position are aligned with the second shuttle track sections 232b of the adjacent array element (FIG. 3B). The first track sections 210a align with the first track sections 210b of the adjacent array element for transport of the container 290 using the stationary wheels 211 of the first track 210.

There are two pairs of actuators 260, each actuator being provided with an L-shaped bracket 361 and to which for each pair both a second track section 220a for a container and a second shuttle track section 232a are provided.

In the relatively low position, the top of the wheels 211 are above the top of the second track section 220a and the shuttle 250 can pass below the second track sections 220a (FIG. 3C).

If the shuttle 250 transports a container 290, it will have to pass the second track section 220a. A shuttle 250 may be provided with two retractable pins 353, which are spaced apart in the X-direction. One extended pin 353 suffices to take the container 290 along, and to pass the second track section 220a the forward pin 353 will first be retracted until it has passed the second track section 220 after which it will be extended and can take the container along when the rearmost second pin 353 is retracted to pass said second track section 220a.

The first track 210 comprises recesses 311 for receiving the second shuttle track sections 232a for the shuttle. In the relatively low position, the top of said second shuttle track sections 232a will be flush with the top of the first track 210, allowing the shuttle 250 to continue along the first track 210 without hindrance.

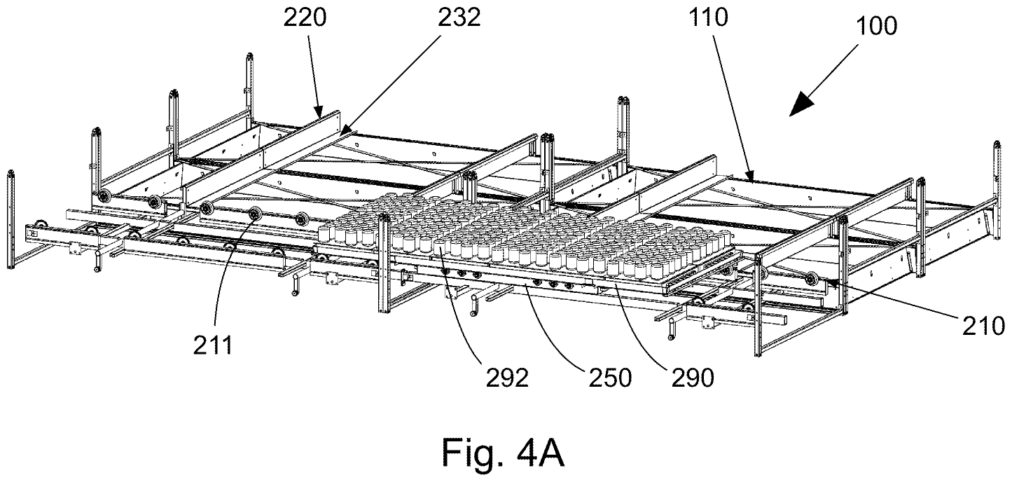

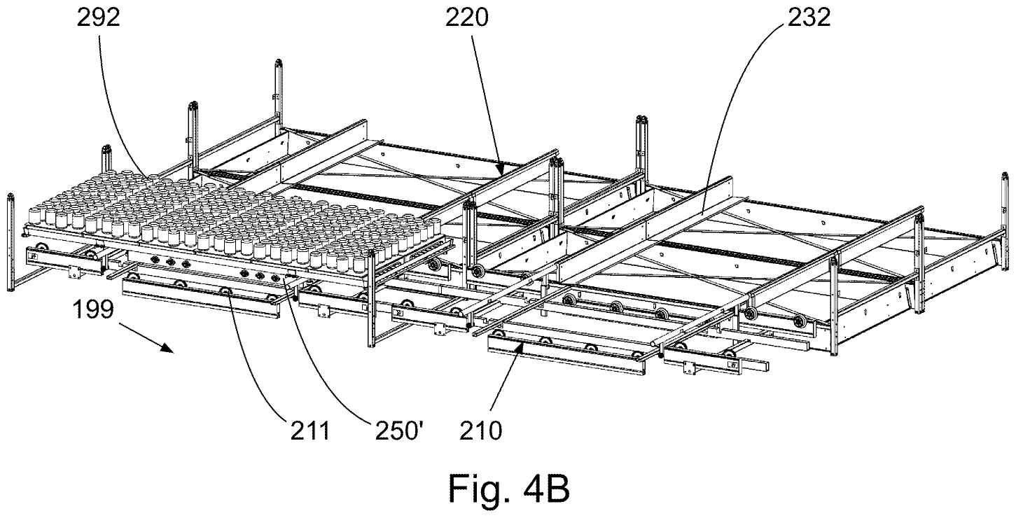

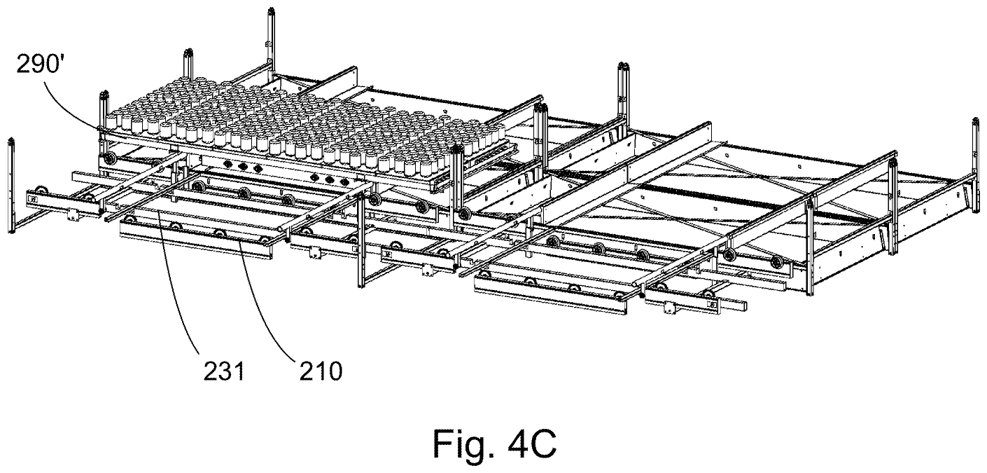

FIG. 4A to FIG. 4C show three perspective views on an alternative system 100 for growing plants 292 in a confined space 199. The system 100 comprises a three-dimensional array of array elements 110, but for the sake of clarity only one layer of the stack of two-dimensional arrays is shown. As shown by way of explanation only, the two-dimensional array is two array elements 110 wide (X-direction) and three array elements 110 long (Y-direction).

A shuttle 250 is depicted moving a container 290 provided with plants 292 in the X-direction along first shuttle track (FIG. 4A) to a location (FIG. 4B) from where the container 290 is moved in the Y-direction (FIG. 4C) as will be explained in more detail below.

For a shuttle 250 moving a container 290, passing the second container sections 220a may need two pins 353 that are lowered and raised consecutively so as to avoid a pin 353 hitting the second container sections 220a.

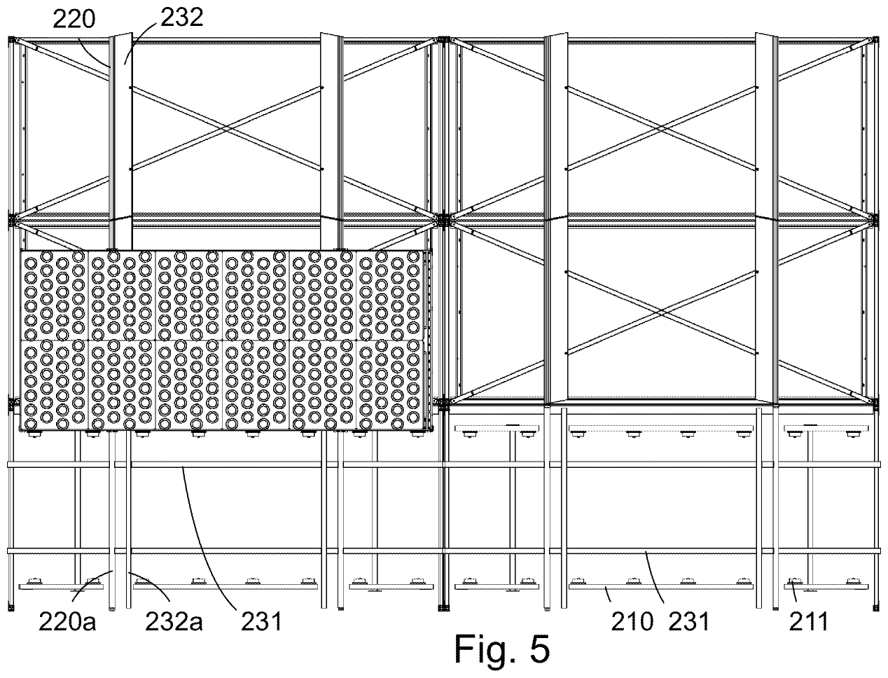

FIG. 5 is a top view of the system 100 of FIG. 4 corresponding to FIG. 4C.

To move in the X-direction, the system 100 comprises the first shuttle track 231 for the shuttle 250. The container 290 rolls on wheels 211 along the first track 210.

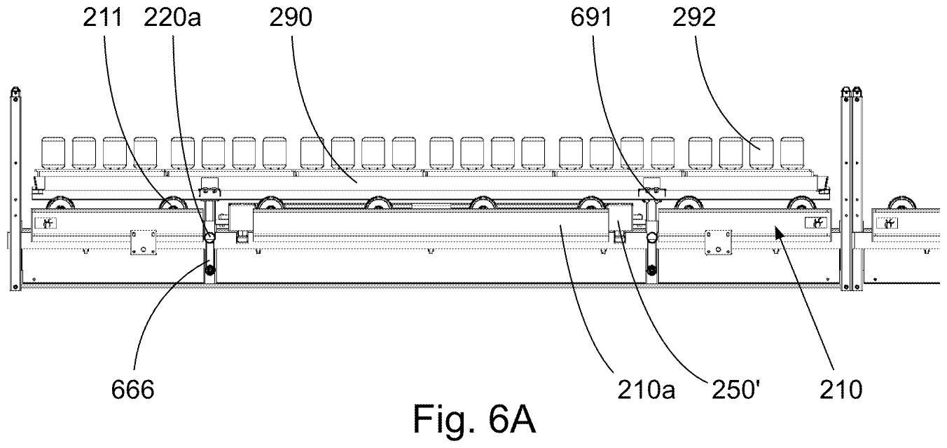

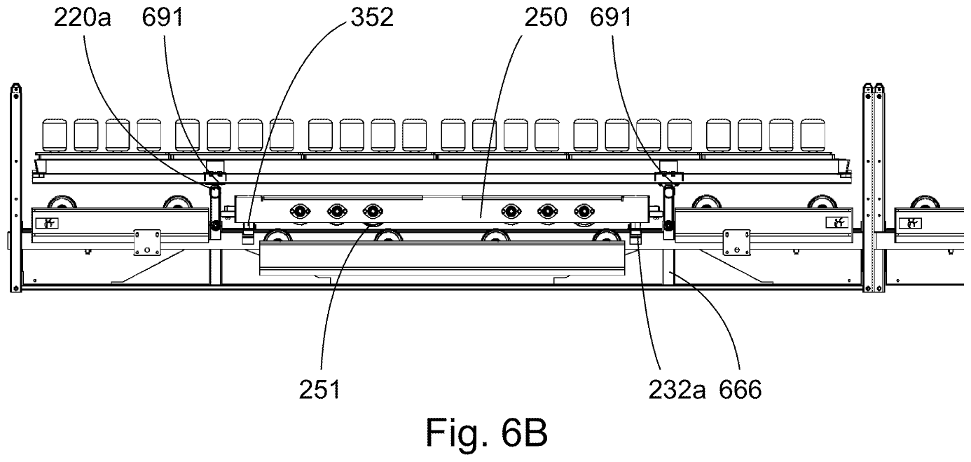

To move in the Y-direction, the system 100 comprises the second shuttle track 232 for the shuttle 250. The container 290 rolls on its own wheels 691 (FIG. 6B) along the second track 220.

FIG. 6A and FIG. 6B show front views of the system of FIG. 4B. To change direction from the X-direction to the Y-direction, the container 290 is lifted from a relatively low position (FIG. 6A) where it is on the first track 210 by lifting second track sections 220a using actuator 666 to a relatively high position wherein said second track sections 220a are aligned with the second track 220.

Simultaneous a second shuttle track section 232a is lifted so as to support the second shuttle wheels 352 and thus support the shuttle 250.

To allow the shuttle to pass the first track 210, first track section 210a is lowered (FIG. 4B, FIG. 4C, FIG. 6B).

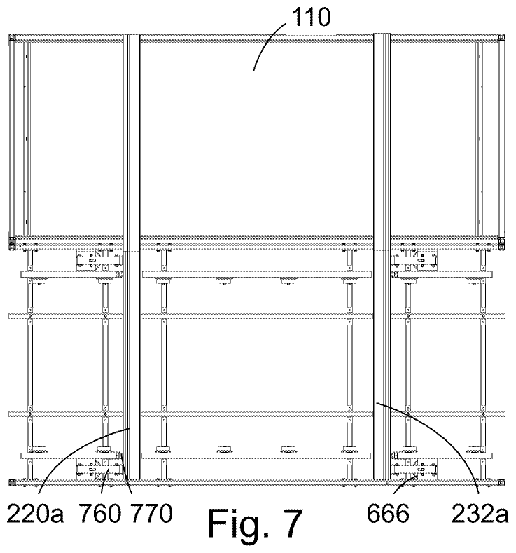

FIG. 7 shows a top view of a second alternative system that substantially corresponds to the alternative system of FIG. 4; only two elements 110 are shown. In this embodiment, the shuttle 250 (not shown) is raised and lowered by (here four) actuators 666, each using a lever arm 760 and a linear vertical guide 770, said lever arm 760 being rotatably connected to bracket for moving the second container track sections 220a and the second shuttle track sections 232b up or down. The second container track sections are received between adjacent first shuttle track portions, and thus are not in the way when a container is moved by a shuttle.

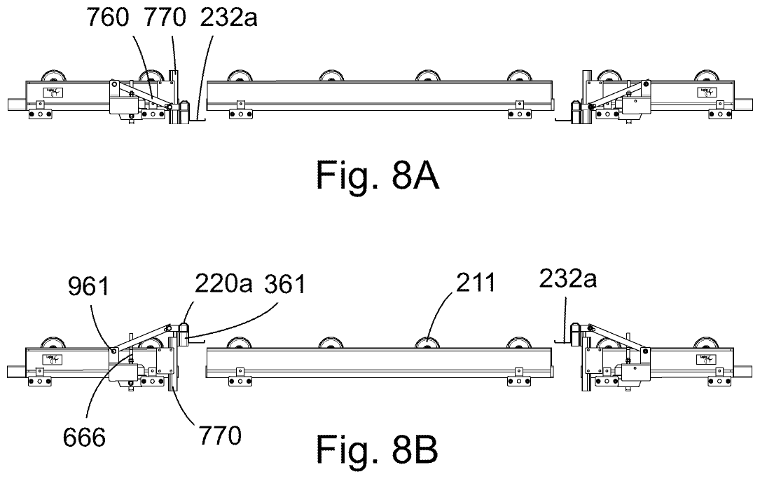

FIG. 8A and FIG. 8B show side views of the second alternative system of FIG. 7.

In FIG. 8A the second track sections are relatively low, allowing for a container and a shuttle to pass in the X-direction.

In FIG. 8B the second track sections are relatively high, allowing for a container and a shuttle to move in the Y-direction.

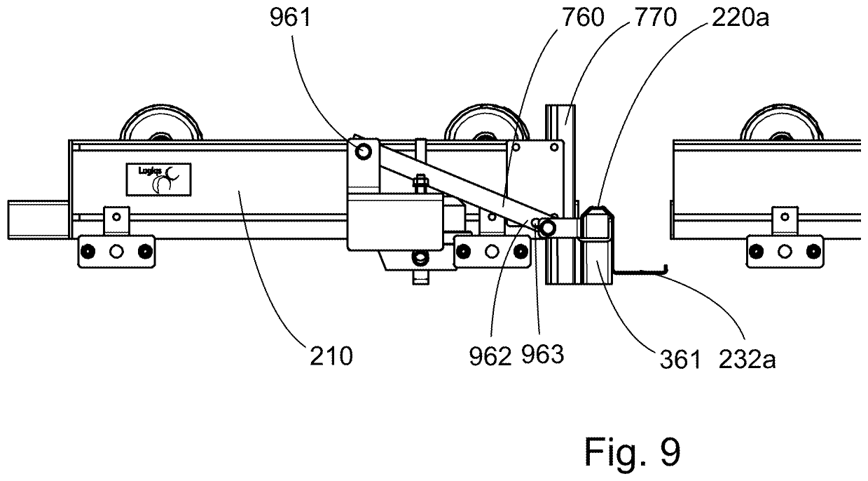

FIG. 9 shows a detail of FIG. 8A. The actuator 666 is capable of moving the lever arm 760 up and down, rotating said lever arm 760 about axis 961. At a distal end 962 of the lever arm 760 a slot 963 is provided holding the bracket 361 so as to compensate for the circular movement of the distal end 962 of the lever arm 760 about the axis 961.

1. A method of growing plants in a confined space, said method comprising:
a plurality of containers for supporting plants, and
a system for storing the containers within the confined space for growing the plants, said system
comprising a three-dimensional array of array elements, said three-dimensional array of array elements comprising a stack of two-dimensional arrays of array elements, and
having
a first main side,
a second main side opposite of the first main side, and
a third main side and a fourth main side, said third main side and said fourth main side extending from the first main side to the second main side;
wherein each two-dimensional array defines a grid of tracks,
said two-dimensional array having
a first side,
a second side opposite of the first side, and
a third side and a fourth side, said third side and said fourth side extending from the first side to the second side;
and
said grid of tracks defining
at least one first track for moving a container in an X-direction transverse to the third side, and
a plurality of second tracks for moving the container in a Y-direction transverse to the first side;
wherein the array elements of the two-dimensional array of array elements are chosen from
a first array element comprising a first track section allowing transport of a container in the X-direction, and
a second array element for storing the containers, said second array element comprising a second track section allowing transport of a container in the Y-direction;
and
a device for moving a container in a vertical direction;
wherein the method comprises the steps of
moving a container along a first track in an X-direction until a second track is reached,
moving said container along the second track to store said container in a second array element,
growing the plants in said stored container,
after growing the plants, retrieving said container from the second array element;
characterized in that
the second array element comprises second shuttle track sections for a shuttle, said second shuttle track sections being
located at a level lower than the second track sections for moving the container, and
running parallel with the second track sections for storing the container;
allowing the shuttle to move the container the shuttle on the second shuttle track sections;
the first array element comprises moveable track sections capable of being in a relatively low position and in a relatively high position, wherein said moveable track sections are chosen from at least one of
i) container track sections for moving the container the Y-direction, and
ii) shuttle track sections for moving the shuttle in the Y-direction;
wherein the system comprises at least one actuator for moving the moveable track sections between the first relatively low position and the second relatively high position;
wherein the step of moving the container to the second track comprises lifting at least one of the container and the shuttle by bringing the moveable track sections from the first relatively low position to the second relatively high position, and moving the container using the shuttle to the adjacent second array element.

2. The method of claim 1, wherein the first array element comprises container track sections, said container track sections being capable of being
in a first relatively low position allowing a shuttle to transport the container in the X-direction, and
in a second relatively high position in line with the second track sections of the adjacent second array element for allowing the movement of the container in the Y-direction;
wherein the system comprises at least one actuator for moving the container track sections the first relatively low position and the second relatively high position;
and wherein the step of lifting the shuttle also comprises the step of moving the container track sections from the first relatively low position to the second relatively high position in line with the second track sections of the adjacent second array element for moving the container in the Y-direction to the second track.

3. The method of claim 2, wherein the first track sections of the first array elements define the first track and comprise passive wheels for supporting the container when it is moved in the X-direction, and
the first array elements comprise second shuttle track sections, said second shuttle track sections,
extending in the X-direction for supporting the shuttle used for moving the container, and
located at a level lower than the first track sections for moving the container;
wherein to move the container along the first track, the shuttle is used to move said container.

4. The method of claim 2, wherein the first array elements comprise container track sections with drivable wheels for moving the container in the X-direction; and
the first array elements comprise second shuttle track sections, said second shuttle track sections,
extending in the X-direction for supporting the shuttle used for moving the container, and
located at a level lower than the first track sections;
wherein to move the container along the first track, the driven wheels are used to move said container.

5. The method of claim 4, wherein the second array elements of the grid of tracks comprise a light source, and light is provided to plants grown in a container stored in a second array element.

6. The method claim 5, wherein the device comprises an elevator for moving a container from the level of a two-dimensional array to the level of another two-dimensional array.

7. The method of claim 6, wherein the elevator for moving a container in a vertical direction is a third array element capable of moving a container in the first direction and the second direction.

8. The method of claim 7, wherein the shuttle comprises
a first set of first shuttle wheels for travelling in the X-direction, said first shuttle wheels defining a first shuttle wheel base plane and the first shuttle wheels having first axes of rotation, and
a second set of second shuttle wheels for travelling in the Y-direction, said second shuttle wheels defining a second shuttle wheel base plane and the second shuttle wheels having second axes of rotation;
wherein the first shuttle wheel base plane is lower than the second shuttle wheel base plane and with the first axes of rotation and the second axes of rotation projected on the first shuttle wheel base plane said projected second axes of rotation being transverse to the projected first axes of rotation.

9. The method of claim 8, wherein the moveable track sections further comprise
moveable container track sections, said container track sections being capable of being
in a first relatively low position allowing a shuttle to transport a container in the X-direction, and
in a second relatively high position in line with the second container track sections of an adjacent second array element, allowing shuttle transport in the Y-direction; and
moveable shuttle track sections, said shuttle track sections being capable of being
in a first relatively low position allowing a shuttle to transport a container in the X-direction, and
in a second relatively high position in line with the shuttle track sections of an adjacent second array element, allowing shuttle transport in the Y-direction;
wherein the system comprises at least one actuator for moving the shuttle track sections between the first relatively low position and the second relatively high position;
wherein
the step of moving a container in the X-direction to a first array element adjacent to a desired second track comprises moving said container while the second container track sections of any first array element involved in moving said container in the X-direction are not higher than the first shuttle track,
the step of moving the container to the second track comprises
lifting the container by bringing the second container track sections from the first relatively low position to the second relatively high position,
lifting the second shuttle track sections so as to support the shuttle, and
moving the container using the shuttle to the adjacent second array element.

10. A system for storing containers within a confined space for growing plants, said system comprising:
a three-dimensional array of array elements, said three-dimensional array of array elements comprising a stack of two-dimensional arrays of array elements, and
having
a first main side,
a second main side opposite of the first main side, and
a third main side and a fourth main side, said third main side and said fourth main side extending from the first main side to the second main side;
wherein each two-dimensional array defines a grid of tracks,
said two-dimensional array having
a first side,
a second side opposite of the first side, and
a third side and a fourth side, said third side and said fourth side extending from the first side to the second side;
and
said grid of tracks defining
at least one first track for moving a container in an X-direction transverse to the third side, and
a plurality of second tracks for moving the container in a Y-direction transverse to the first side;
wherein the array elements of the two-dimensional array of array elements are chosen from
a first array element comprising a first track section allowing transport of a container in the X-direction, and
a second array element for storing the containers, said second array element comprising a second track section allowing transport of a container in the Y-direction;
and
a device for moving the container in a vertical direction, characterized in that the second array element comprises second shuttle track sections for a shuttle, said second shuttle track sections being
located at a level lower than the second track sections for moving the container, and
running parallel with the second track sections for storing the container;
allowing the shuttle to move the container with the shuttle on the second shuttle track sections;
the first array element comprises moveable track sections capable of being in a relatively low position and in a relatively high position, wherein said moveable track sections are chosen from at least one of
container track sections for moving the container in the Y-direction, and
ii) shuttle track sections for moving the shuttle in the Y-direction;
wherein the system comprises at least one actuator for moving the moveable track sections between the first relatively low position and the second relatively high position.
